(19) United States
(12) Patent Application Publication
(10) Pub. No.: US 2007/0289967 A1
(43) Pub. Date: Dec. 20, 2007

(54) Bin Compactor

(76) Inventors: Guy William Pierce, Quorn (AU); Peter James Cormack, Quorn (AU)

Correspondence Address: AKERMAN SENTERFITT, P.O. BOX 3188, WEST PALM BEACH, FL, 33402-3188, US

(21) Appl. No.: 10/599,364

(22) PCT Filed: Mar. 29, 2005
(86) PCT No.: PCT/AU05/00428

§ 371 Date: May 7, 2007

(30) Foreign Application Priority Data
Mar. 26, 2004 (AU) 2004901617

(51) Int. Cl. B65F 1/14

(52) U.S. Cl. 220/212; 100/233; 220/495.06; 220/495.07; 220/553

(57) ABSTRACT

A rubbish receptacle or bin including a container with an uppermost lid which is connected to the container by a pivot connection about an axis so that it can assume, by being pivoted about its pivot connection, a closed position with respect to an otherwise open top of the container and in a further open position whereby access for introduction of rubbish into the container can be achieved, wherein there is a compactor which is located so as to be below the lid when the lid is in a closed position with respect to the otherwise open top of the container.

### TECHNICAL FIELD

The present invention relates to a trash compacting lid assembly for a bin and a bin with a rubbish compacting facility.

### BACKGROUND ART

Previous attempts have been made to design a bin with a lid that includes means for compacting the contents of the bin. There are some examples in prior patent specifications, for example Patent WO 97/43196 (which is not admitted to be common general knowledge) discloses such a bin.

A problem with the bin compaction arrangement disclosed in this patent specification however is that the mechanism for effecting compaction is exposed and does not provide an arrangement that might be attractive to a user, especially where the bin may be used in a domestic situation.

There is a further problem, which is to provide an assembly and a bin that allows for an efficient mechanism, which can also be arranged to provide a good compaction pressure and a closure facility.

It is an object of the present invention to provide a bin with a rubbish compacting lid assembly and an assembly for a bin that overcomes or at least ameliorates the above problem with the compacting bins of the prior art.

Other objects and advantages of the present invention will become apparent from the following description, taken in connection with the accompanying drawings, wherein, by way of illustration and example, an embodiment of the present invention is disclosed.

### DISCLOSURE OF THE INVENTION

A rubbish receptacle or bin including a container with an uppermost lid which is connected to the container by a pivot connection about an axis so that it can assume, by being pivoted about its pivot connection, a closed position with respect to an otherwise open top of the container and in a further open position whereby access for introduction of rubbish into the container can be achieved, characterized in that there is a compactor which is located so as to be below the lid when the lid is in a closed position with respect to the otherwise open top of the container, the compactor being supported at a rearward location by a first pivot connection with the container with an axis which is aligned to be parallel to the axis of the pivot connection of the lid to the container, and being supported at a forward location by a pivot connection pivotable about a parallel axis to the first pivot axis, to a link which has its further end pivotally connected to the lid with an axis parallel to the first pivot axis, the location of the axis of the pivot connection of the link with the lid being such that when the lid is closed the pivot connection axis is further forward than the pivot axis of the lid to the container, and rearward of the axis of the pivot connection of the link to the compactor, and beneath a plane defined by the axis of the said first pivot connection and the axis of the pivot connection of the link to the compactor, and when the lid is being opened, the pivot axis of the link to the lid is caused to progress through the said plane and then as the opening of the lid progress's, further away from the plane defined by the axis of the said first pivot connection and the axis of the pivot connection of the link to the compactor.

Preferably, there is a resilient biasing means arranged to urge the lid into an open position.

Preferably, there is an opening located through a side of the bin and below the compactor when this is in a compacting position with the lid closed.

Preferably, there is an arrangement to support a liner with respect to the compactor.

Preferably, there are means to support a roller supporting a roll of liner or liners and positioned such that the liner can be unwound from the roll to be positioned across a compacting surface of the compactor.

Preferably, there are foot operable means to effect a lowering of the lid together with the compactor into a compacting position.

Preferably, there are foot operable means to lift the lid from a closed position.

Preferably, the container is divided into two or more separate compartments via dividing walls.

In a further form, the invention may be said to lie in a compactor lid assembly for attachment to a top of a rubbish receptacle or bin, such that the assembly includes a rim arranged to locate over and be attached to a top of a bin, a lid pivotally secured to a side of the rim, a compactor, the lid and compactor both being pivotally connected to the rim at or toward respective first ends, the pivot connections in each case being parallel one with respect to the other, and with the pivot connection of the lid being higher than the pivot connection of the compactor when the assembly is positioned for use on an uppermost open top bin, a link with a first end pivotally connected to at or toward a second end of the compactor with an axis which is parallel to the axis of the first said pivot connections, a second end of the link being pivotally connected to the lid with an axis that is parallel to the said first said pivot connection and, when the lid is in a closed position is lower than a plane defined by the respective axes of the pivot connection of the compactor to the rim, and the pivot connection of the link to the compactor, and this relative positioning is changed as the lid is opened to where the axis of the pivot connection of the link to the lid is above the plane.

In a further form, the invention may be said to lie in a rubbish receptacle or bin including a container with an uppermost lid which is connected to the container by a pivot connection so that it can assume by being pivoted about its pivot connection into a closed position with respect to an otherwise open top of the container and in a further position an open position whereby access for introduction of rubbish into the container can be achieved, characterized in that there is a compactor which is located so as to be below the lid when this is in a closed position with respect to the otherwise open top of the container, and is supported at a rearward location by a first pivot connection with the container which is aligned to be parallel to the pivot connection of the lid to the container, and which is attached at a forward location of the compactor by a pivot connection about a parallel axis to the first pivot, to at least one link which has its further end pivotally connected to the lid with an axis parallel to the first said link, the relative position of the pivot connections being such that the compactor which includes a compactor member is caused to be lowered with a compacting action as the lid is brought into a closed position, and where an extent of mechanical advantage is achieved between any force applied to the lid as compared to a resultant compacting force provided by the compactor against any rubbish within the container is increased as the lid is closed.

In a further form, the invention may be said to lie in a rubbish receptacle or bin including an uppermost opening and a compacting lid assembly which includes a lid arranged to close the opening of the bin, and positioned beneath the lid, a compacting pressure applying part, the lid being connected at a first end to be rotatable about an approximately horizontal axis which is located in the vicinity of a one side of the bin, and such that by rotation about the axis it can be moved from a position allowing access for trash being placed through the opening into the bin, and in a further position fully closes the opening of the bin, a lower compacting pressure applying part pivotally connected to be rotatable with respect to the bin at or toward a respective first end, of the part such that the pivot points of the lid to the bin and the part to the bin are at least vertically spaced apart; a first end of a link being pivotally connected at or toward a second end of the compacting element, a second end of the link being pivotally connected to the lid with an axis the location of which changes as the lid is opened from a closed position from a position where the axis is below a plane defined by the respective axes of the pivot connections of the part to the bin and the link to the part, to a position where the axis is above this plane as the opening progress's.

In a further form, the invention may be said to lie in a compacting lid assembly including a rim adapted to interengage with an opening of a bin, an upper lid element arranged to close the opening to the rim, a lower compacting element adapted to compact the contents of the bin, the upper and lower elements both being pivotally connected to the rim at respective first ends, such that the pivot points are at least vertically spaced apart; a link, the first end of which is pivotally connected to a second end of the compacting element, the second end of the link being pivotally connected to the lid at a point that remains between the pivot point for the first end of the connecting element and the pivot point of the lid throughout the arc of the lids travel.

In a further form, the invention may be said to lie in a rubbish receptacle or bin being a container with an uppermost lid which is connected to the container by a pivot connection so that it can assume by being pivoted about its pivot connection into a closed position with respect to an otherwise open top of the container and in a further position an open position whereby access for introduction of rubbish into the container can be achieved, characterized in that there is a compactor which is located so as to be below the lid when this is in a closed position with respect to the otherwise open top of the container, and is supported at a rearward location by a first pivot connection with the container which is aligned to be parallel to the pivot connection of the lid to the container, and which is attached at a forward location of the compactor by a pivot connection about a parallel axis to the first pivot, to at least one link which has its further end pivotally connected to the lid with an axis parallel to the first said link, the relative position of the pivot connections being such that the compactor which includes a compactor member is caused to be lowered with a compacting action as the lid is brought into a closed position, and where an extent of mechanical advantage is achieved between any force applied to the lid as compared to a resultant compacting force provided by the compactor against any rubbish within the container is increased as the lid is closed.

### BRIEF DESCRIPTION OF THE DRAWINGS

For a better understanding of this invention it will now be described with respect to the preferred embodiment which shall be described herein with the assistance of drawings, wherein;

FIG. 1 is a perspective view of a bin fitted with a rubbish compacting assembly;

FIG. 1b is a perspective view of the bin in FIG. 1, showing the rubbish compacting assembly separated from the bin;

FIG. 1c is a perspective view of the bin and rubbish compacting assembly in FIG. 1, showing the lid in a closed position;

FIG. 2 is a side plan view of the bin and rubbish compacting assembly in FIG. 1;

FIGS. 3a to e are side plan views of the bin and rubbish compacting assembly in FIG. 1 showing it in use;

FIG. 3f is a detail cross-sectional view through the bin and rubbish compacting assembly In FIGS. 3a to e;

FIGS. 4 to c are side plan views of a further form of the rubbish compacting lid assembly as fitted to a larger wheeled bin;

FIGS. 5a to c are side plan views of a further form of the rubbish compacting lid assembly, fitted with a lid opening mechanism;

FIG. 6 is a side plan view of a further form of the rubbish compacting lid assembly, mounted under a kitchen bench top;

FIGS. 7a and b are perspective views of a kitchen bin incorporating the compacting lid assembly according to the invention;

FIG. 8 is a side view of the bin in FIG. 6;

FIGS. 9a and b are side views of a bin incorporating a foot operated lid opening mechanism; and

FIGS. 10a to c are perspective views of a bin incorporating an arrangement to support a liner with respect to the compactor.

### BEST MODE FOR CARRYING OUT THE INVENTION

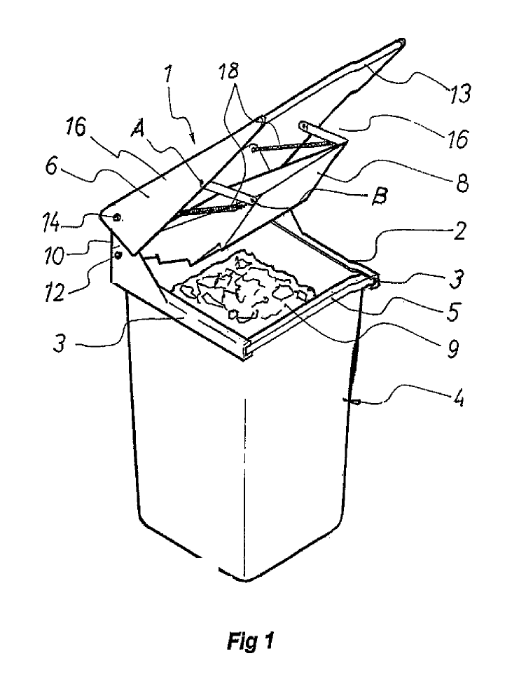

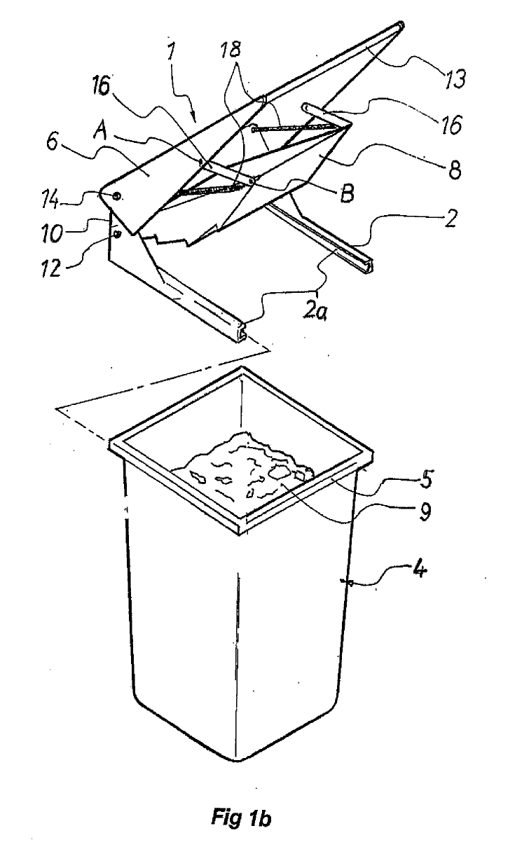

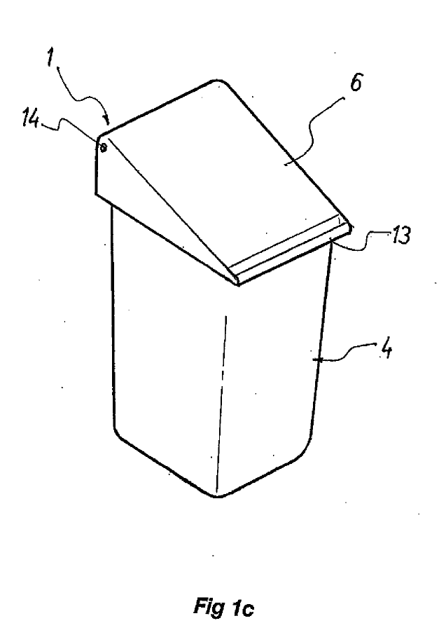

Now referring to the illustrations, and in particular to FIG. 1, there is a compacting lid assembly 1 including a rim 2, that is adapted to interlock with the uppermost perimeter of a bin 4.

The rim 2 is adapted to be securely fastened to the bin 4. This is by means of a pair of downwardly and inwardly extending lips 3 on two sides of the assembly, which define channels 2a that engage a lip 5 found at the opening of most conventional domestic ‘kitchen’ bins made from plastic.

It is to be understood by a person skilled in the relevant art, that while the assembly is illustrated as a unit that can be adapted fit to a bin such that it is removable, it can also be provided in the form of a bin with the unit permanently attached.

There is an uppermost lid 6 arranged to close an opening to the bin, and a lower compactor 8 to compact the contents of the bin 9 during the closing process, as the lid 6 is closed.

The rim 2, has a high back 10 on one edge, which allows for both the lid 6 and compactor 8 to be supported by and connected to the rim at a rearward location by a pivot connection about an axis such that the pivot point and axis 14 for the lid 6 is attached to the rim at a point above the pivot point and axis 12 for the compactor 8. The pivot point axes for the lid and compactor are parallel. At its other end, the lid 12 has a handle 13.

There is a pair of connecting links 16, one on each side of the compacting element, a first end of each being connected by a pivot connection that is pivotable about an axis parallel to the aforementioned pivot axes, to the compactor 8. A second end of each connecting link is also connected by a pivot connection that is pivotable about an axis parallel to the aforementioned pivot axes, to the lid 12, and the handle. The links 16 transmit the force applied by a user at the handle of the lid to the compacting element. Furthermore, the links ensure that the compacting element is pulled out of the way when the lid of the bin is opened.

The components of the compacting assembly 1 can be fabricated out of sheet metal, or moulded in an engineering plastic, depending upon the intended size and application.

The relative position of the links' 16 pivot connections is such that as the lid 6 is brought into a closed position the compactor 8 is lowered with a compacting action, and a mechanical advantage is achieved between any force applied to the lid as compared to a resultant compacting force provided by the compactor against any rubbish within the container, the mechanical advantage being increased as the lid is closed.

The location of the axis of the pivot connection A of the link 16 with the lid 6 is such that when the lid is closed the pivot connection axis A is further forward than the pivot axis 14 of the lid 6 to the container 4, and rearward of the axis of the pivot connection B of the link 16 to the compactor 8, and beneath a plane defined by the axis of the said first pivot connection 14 and the axis of the pivot connection B of the link to the compactor. When the lid 6 is being opened, the pivot axis A of the link to the lid 6 is caused to progress through the said plane and then as the opening of the lid 6 progress's, further away from the plane defined by the axis of the said first pivot connection 14 and the axis of the pivot connection B of the link to the compactor.

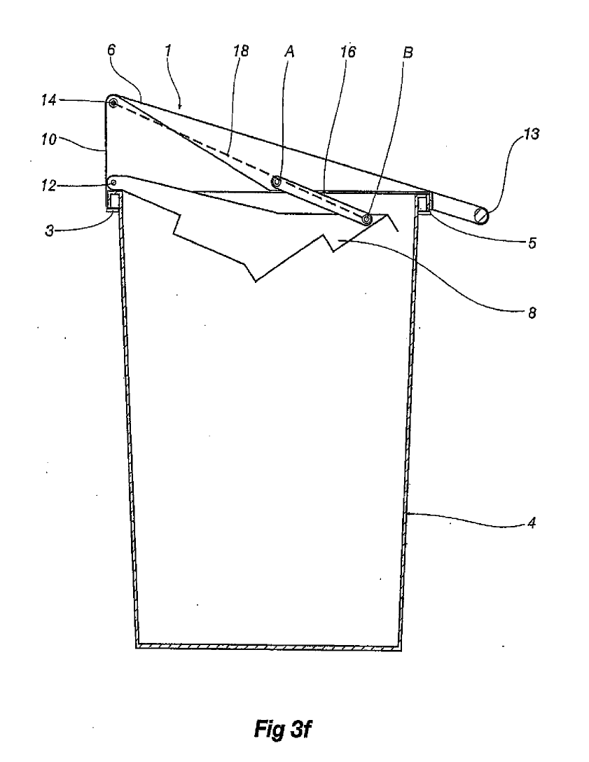

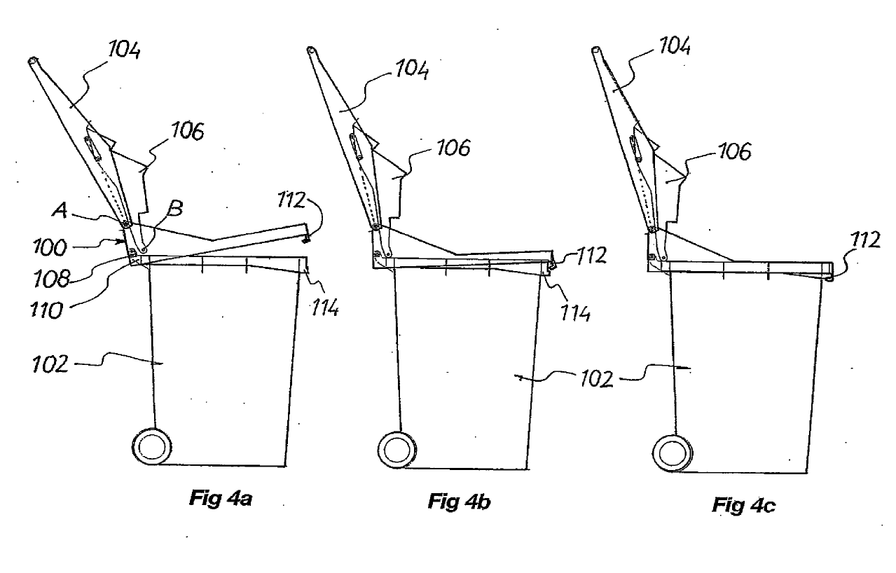

Referring now to FIGS. 3a to e, the arrangement of the assembly is such that there is a mechanical advantage created; furthermore, as the lid is closed, the mechanical advantage of the arrangement increases, as the load moment arm L decreases. This mechanical advantage will be of increasing advantage for larger bins, where the benefit of the mechanical advantage inherent in this arrangement would become even more appreciable.

In this example, there are a pair of springs 18, one each side of the compacting element 8, extending between the point at which the link pivotally connects to the second end of the compacting element B, and the pivot point of the lid element 14. In some of the drawings these springs 18 are illustrated using a dashed line. The purpose of the spring is to offset to at least some degree the weight of the compacting element. Referring now to FIG. 3f, when the lid 6 is in the closed position, the line of action of the link, which is defined as the line between the pivotal attachment points A and B at either end of the link 16, passes through the plane or line of action of the spring 18, until the end A of the link that is attached to the lid 6 is below the line of action of the spring 18; this creates an over centre locking effect, so that the load in the spring causes to hold the lid shut, and the lid will not open on its own. If however the lid is opened a little, the link will again pass through the line of action of the spring, and once further opening destroys this alignment, the spring, if sufficiently powerful, can open the lid to the full extent of its travel. Various features or mechanisms may be employed to assist a user to move the lids link through the line of action of the spring so that the lid may be opened. These might include a shelf attached to the rim of the bin, which is adapted to allow the four fingers of a hand to push against, whilst the thumb of the hand wraps around and grips the handle and lifts the lid. Alternatively, the bin may include a foot pedal, so that a users foot can anchor the bin whilst their hand lifts the lid.

When the lid is closed, the waste remains under the compressive effects of the compacting element. After remaining under this compressive loading for a while, it has been observed that the waste material looses its elasticity, so that the next time the lid is opened, the material does not spring back, and the space occupied by the compacting element when the lid is closed, remains free to accept further waste. Consequently, the compacting effort does not increase with each and every successive use of the bin and its compactor, instead only a small amount of effort is required to compact the newly introduced waste.

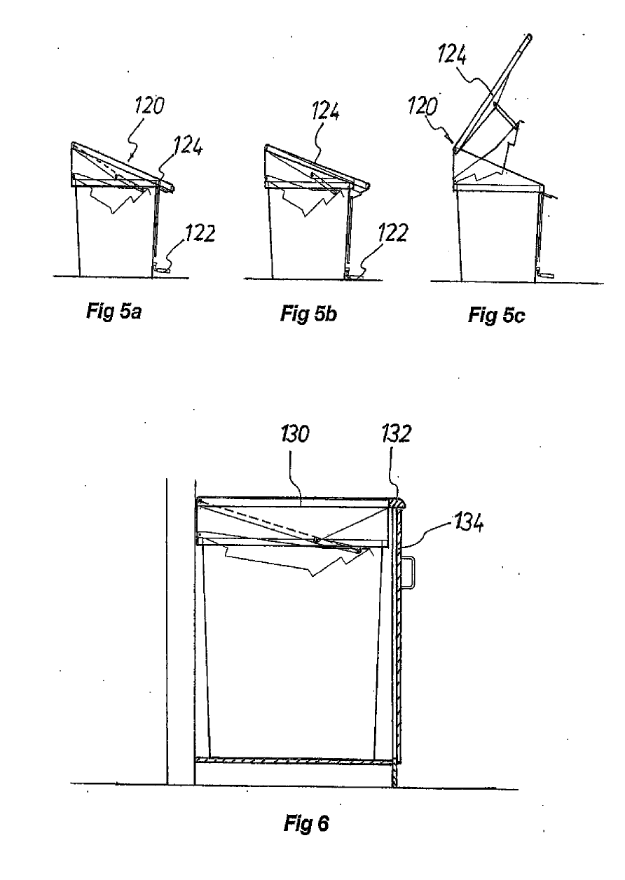

Referring now to FIGS. 4a to d, which illustrate a further form of the invention, wherein the compactor assembly 100 is adapted to be fitted to a conventional ‘wheelie bin’ 102. This compacting assembly is arranged so that the lid 104 and compacting element 106 can open even further. This is important, if the assembly is to be capable of surviving the truck based lifting and emptying systems employed by most councils. The lid 104 and compacting element 106 are adapted then so that they are clear of any rubbish failing out of the bin 102 when it is inverted during emptying operations. This is achieved by setting the pivot points of both the lid and compacting elements further back from the front of the bin, furthermore, the pivot point for the lid is set further back than the pivot point of the compacting element.

The assembly can be fitted to the bin via a first lip 108 along the back of the assembly 100 that engages the handle of the bin 110, and a second lip 112 in the front of the assembly 100 that engages the front rim 114 of the bin.

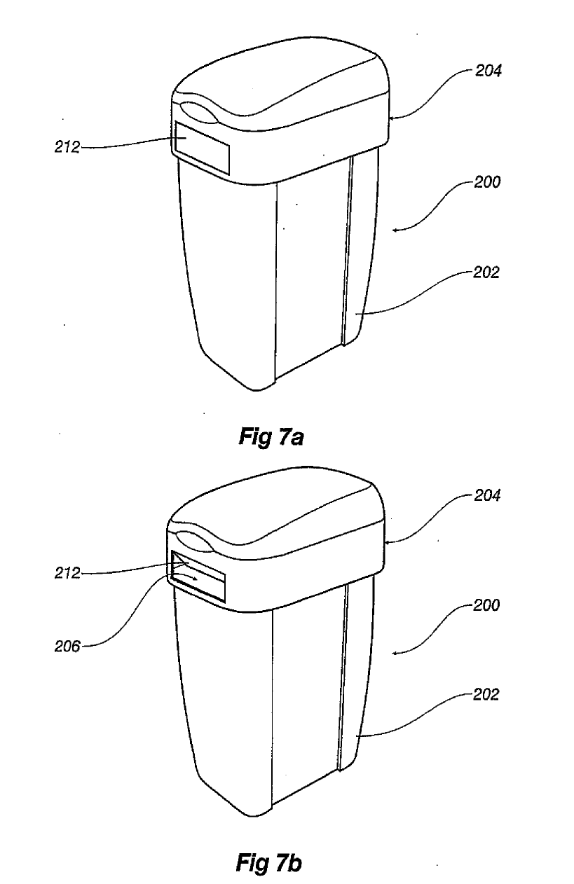

Referring now to FIG. 5, which illustrates an assembly for a kitchen bin assembly 120, that incorporates a pedal 122 operated mechanism of initiating opening of the lid 124.

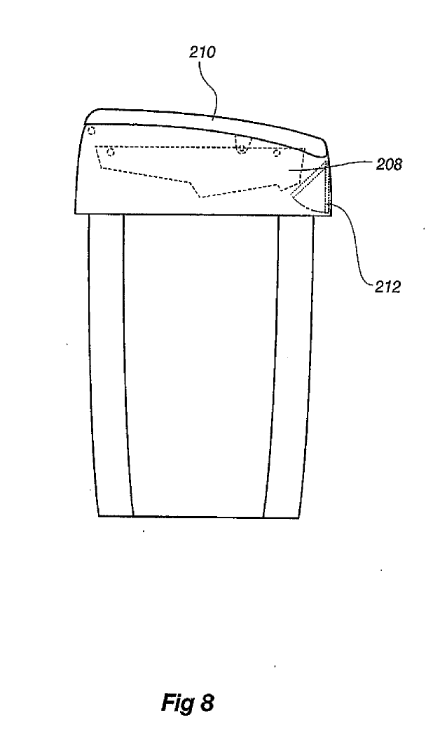

FIG. 6 illustrates an assembly with a lid 130 that firstly has a horizontal closed position as opposed to a forward and downwardly sloping one. In addition, the upper surface of the lid in this instance forms part of the bench top 132, and the bin itself is in a cupboard 134.

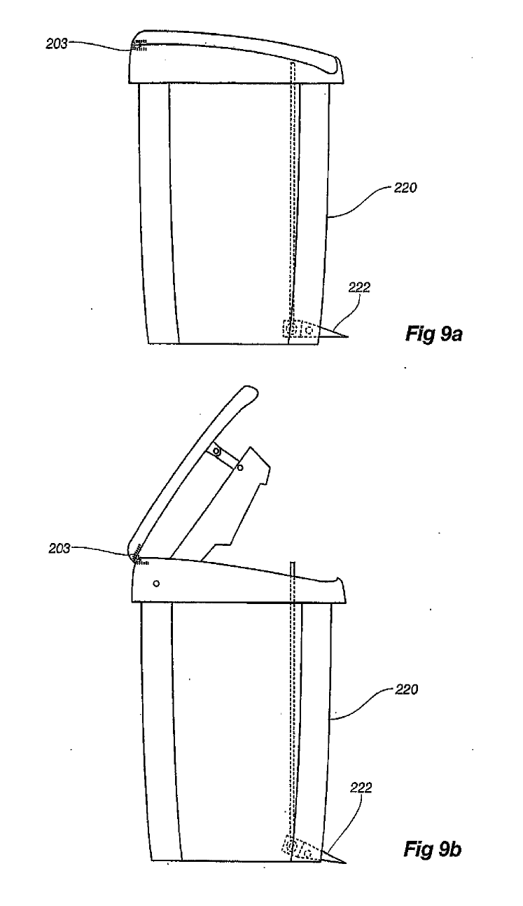

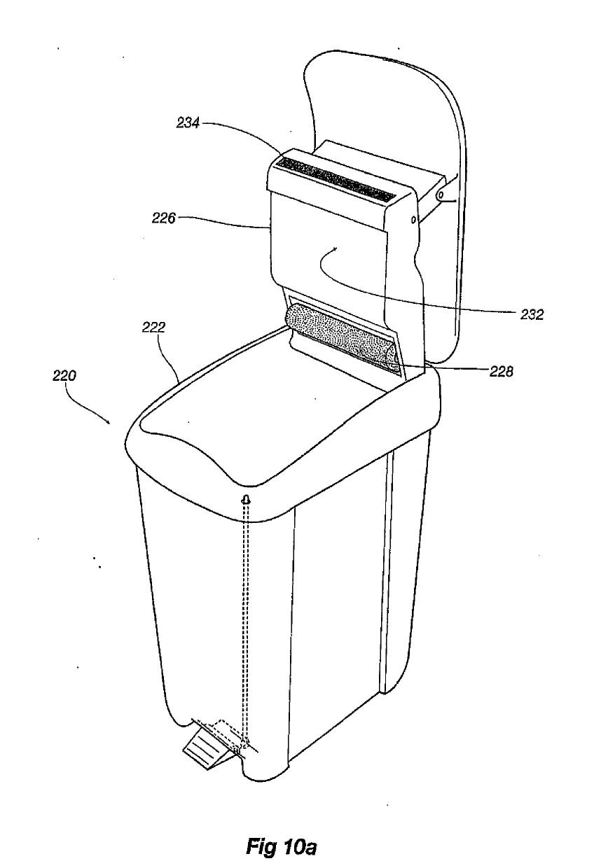

Referring now to FIGS. 7 through 10, where a domestic bin 200 suitable for use inside a home is disclosed. This bin is made from a plastic material and has been styled for improved aesthetics that would make it acceptable for placement in a kitchen or bathroom for instance. The bin 200 includes a container portion 202 and a combined lid and compactor assembly 204 that can be removably attached to the container to facilitate emptying.

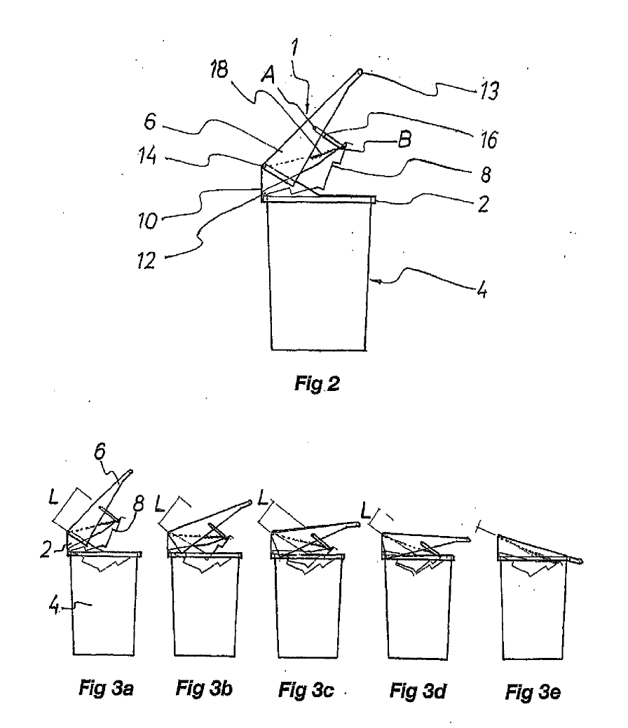

The compaction assembly in this bin is arranged and operates in the exact same fashion as the rubbish compacting assembly illustrated in FIGS. 1 through 6, except that where that assembly utilized axial springs, this bin uses a torsion spring 203 to urge the lid into an open position. The advantage of using a torsion spring is that this is more easily concealed.

Referring now to FIGS. 7a and b in particular, where the combined lid and compactor assembly 204 includes an opening 206 located through a side of the assembly, but below the compactor 208 when this is in a compacting position with the lid 210 closed. A flap 212 covers this opening, and it permits rubbish to be placed in the bin in instances when compaction is not required, and the lid 210 then does not need to be raised.

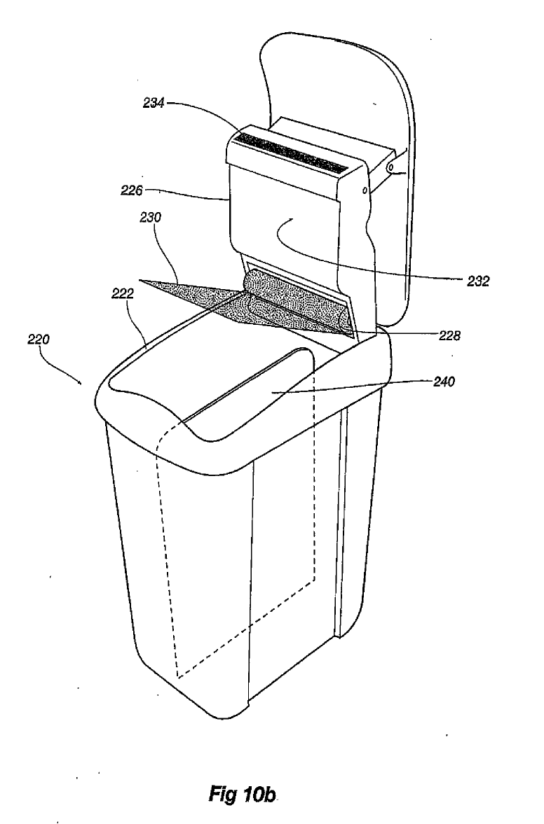

The bin 220 in FIGS. 9a and b includes a foot operable means 222 to lift the lid from a closed position. This allows the user to lift the lid without having to touch the bin with their hands. Furthermore, a similar foot operated mechanism could be incorporated to facilitate closing of the lid and compaction of the rubbish. This is considered to be particularly useful in food preparation areas in particular.

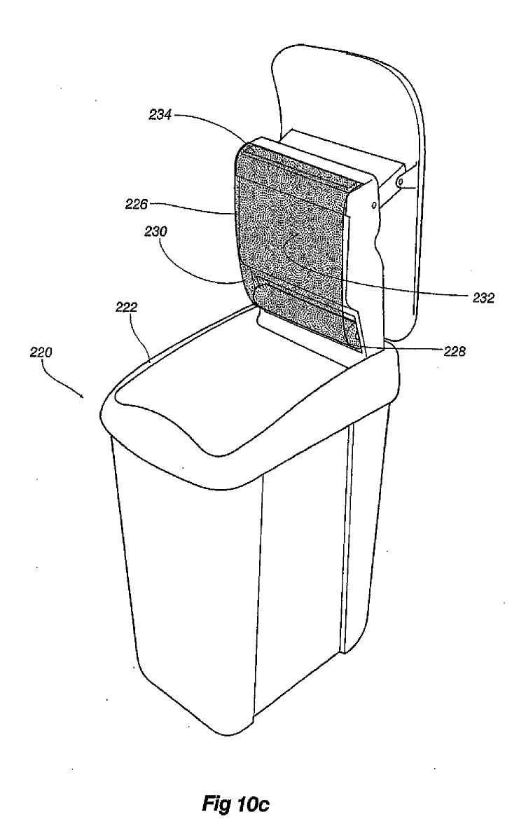

Referring now to the bin 220 in FIGS. 10a through c, where the combined lid and compactor assembly 222 includes an arrangement to support a liner with respect to the compactor 226.

The compactor 226 supports a roller supporting a roll 228 of liner 230 or liners such that the liner 230 can be unwound from the roll 228 and positioned across the compacting surface 232 of the compactor 226, where it is held in place by an adhesive strip 234 attached to the compactor 226. This liner prevents the compacting surface from being covered with rubbish to a substantial extent. When the liner becomes unsightly or indeed putrid this can be discarded and a new liner drawn from the roller and applied to the compacting surface.

Referring now to FIG. 10b, where the bin container illustrated is divided into two separate compartments by a dividing wall. One compartment may be for recyclable waste such as bottles, cartons and cans, and the other compartment may be for non-recyclable waste. The compactor 226 will then compact waste added to either side of the divider when the lid is closed. It would be understood by a person skilled in the art that a relief slot for the dividing wall may be included in the compactor, allowing the compactor to encroach into the compartments created by the dividing wall, thereby compacting waste below the uppermost edge of the dividing wall.

A significant advantage of the rubbish compacting lid assembly for a bin according to the present invention is that the spring(s) will offset the weight of the compacting element when the lid is being opened, and yet the lid, when closed, will remain closed without the need for using catches or the like to hold the lid shut.

It is considered therefore that a rubbish compacting lid assembly for a bin such as that described herein would prove to be of considerable benefit to those who wish to maximize the storage capacity of their bin while allowing for a very efficient mechanism.

1. A rubbish receptacle or bin comprising a container with an uppermost lid which is connected to the container by a pivot connection about an axis so that it can assume, by being pivoted about its pivot connection, a closed position with respect to an otherwise open top of the container and in a further open position whereby access for introduction of rubbish into the container can be achieved, comprising a compactor which is located so as to be below the lid when the lid is in a closed position with respect to the otherwise open top of the container, the compactor being supported at a rearward location by a first pivot connection with the container with an axis which is aligned to be parallel to the axis of the pivot connection of the lid to the container, and being supported at a forward location by a pivot connection pivotable about a parallel axis to the first pivot axis, to a link which has its further end pivotally connected to the lid with an axis parallel to the first pivot axis, the location of the axis of the pivot connection of the link with the lid being such that when the lid is closed the pivot connection axis is further forward than the pivot axis of the lid to the container, and rearward of the axis of the pivot connection of the link to the compactor, and beneath a plane defined by the axis of the said first pivot connection and the axis of the pivot connection of the link to the compactor, and when the lid is being opened, the pivot axis of the link to the lid is caused to progress through the said plane and then as the opening of the lid progress's, further away from the plane defined by the axis of the said first pivot connection and the axis of the pivot connection of the link to the compactor.

2. The rubbish receptacle as in claim 1 further comprising a resilient biasing means positioned and tensioned to tension the lid into an open position.

3. The rubbish receptacle as in claim 1 further comprising an opening located through a side of the bin and below the compactor when this is in a compacting position with the lid closed.

4. The rubbish receptacle as in claim 1 further comprising engagement members to support a liner with respect to the compactor.

5. The rubbish receptacle as in claim 1 further comprising a structure to support a roller supporting a roll of liner or liners and positioned such that the liner can be unwound from the roll to be positioned across a compacting surface of the compactor.

6. The rubbish receptacle as in claim 1 further comprising foot operable means to effect a lowering of the lid together with the compactor into a compacting position.

7. The rubbish receptacle as in claim 1 further comprising a foot operable pedal and a connecting member or members to a portion of the lid arranged so that with depression of the pedal the lid will be lifted from a closed position.

8. The rubbish receptacle as in claim 1 further comprising at least two separate compartments divided by one or more dividing walls.

9. A compactor lid assembly for attachment to a top of a rubbish receptacle or bin, the assembly comprising a rim arranged to locate over and be attached to a top of a bin, a lid pivotally secured to a side of the rim, a compactor, the lid and compactor both being pivotally connected to the rim at or toward respective first ends, the pivot connections in each case being parallel one with respect to the other, and with the pivot connection of the lid being higher than the pivot connection of the compactor when the assembly is positioned for use on an uppermost open top bin, a link with a first end pivotally connected to at or toward a second end of the compactor with an axis which is parallel to the axis of the first said pivot connections, a second end of the link being pivotally connected to the lid with an axis that is parallel to the said first said pivot connection and, when the lid is in a closed position is lower than a plane defined by the respective axes of the pivot connection of the compactor to the rim, and the pivot connection of the link to the compactor, and this relative positioning is changed as the lid is opened to where the axis of the pivot connection of the link to the lid is above the plane.

10. A rubbish receptacle or bin including a container with an uppermost lid which is connected to the container by a pivot connection so that it can assume by being pivoted about its pivot connection into a closed position with respect to an otherwise open top of the container and in a further position an open position whereby access for introduction of rubbish into the container can be achieved, comprising a compactor which is located so as to be below the lid when this is in a closed position with respect to the otherwise open top of the container, and is supported at a rearward location by a first pivot connection with the container which is aligned to be parallel to the pivot connection of the lid to the container, and which is attached at a forward location of the compactor by a pivot connection about a parallel axis to the first pivot, to at least one link which has its farther end pivotally connected to the lid with an axis parallel to the first said link, the relative position of the pivot connections being such that the compactor which includes a compactor member is caused to be lowered with a compacting action as the lid is brought into a closed position, and where an extent of mechanical advantage is achieved between any force applied to the lid as compared to a resultant compacting force provided by the compactor against any rubbish within the container is increased as the lid is closed.

11. A rubbish receptacle or bin including an uppermost opening and a compacting lid assembly which includes a lid arranged to close the opening of the bin, and positioned beneath the lid, a compacting pressure applying part, the lid being connected at a first end to be rotatable about an approximately horizontal axis which is located in the vicinity of a one side of the bin, and such that by rotation about the axis it can be moved from a position allowing access for trash being placed through the opening into the bin, and in a further position fully closes the opening of the bin, a lower compacting pressure applying part pivotally connected to be rotatable with respect to the bin at or toward a respective first end, of the part such that the pivot points of the lid to the bin and the part to the bin are at least vertically spaced apart; a first end of a link being pivotally connected at or toward a second end of the compacting element, a second end of the link being pivotally connected to the lid with an axis the location of which changes as the lid is opened from a closed position from a position where the axis is below a plane defined by the respective axes of the pivot connections of the part to the bin and the link to the part, to a position where the axis is above this plane as the opening progress's.

12. A compacting lid assembly including a rim adapted to interengage with an opening of a bin, an upper lid element arranged to close the opening to the rim, a lower compacting element adapted to compact the contents of the bin, the upper and lower elements both being pivotally connected to the rim at respective first ends, such that the pivot points are at least vertically spaced apart; a link, the first end of which is pivotally connected to a second end of the compacting element, the second end of the link being pivotally connected to the lid at a point that remains between the pivot point for the first end of the connecting element and the pivot point of the lid throughout the arc of the lids travel.

13. A rubbish receptacle or bin being a container with an uppermost lid which is connected to the container by a pivot connection so that it can assume by being pivoted about its pivot connection into a closed position with respect to an otherwise open top of the container and in a further position an open position whereby access for introduction of rubbish into the container can be achieved, wherein there is a compactor which is located so as to be below the lid when this is in a closed position with respect to the otherwise open top of the container, and is supported at a rearward location by a first pivot connection with the container which is aligned to be parallel to the pivot connection of the lid to the container, and which is attached at a forward location of the compactor by a pivot connection about a parallel axis to the first pivot, to at least one link which has its further end pivotally connected to the lid with an axis parallel to the first said link, the relative position of the pivot connections being such that the compactor which includes a compactor member is caused to be lowered with a compacting action as the lid is brought into a closed position, and where an extent of mechanical advantage is achieved between any force applied to the lid as compared to a resultant compacting force provided by the compactor against any rubbish within the container is increased as the lid is closed.

14. (canceled)

15. (canceled)
